(19) United States
(12) Patent Application Publication
(10) Pub. No.: US 2026/0065566 A1
(43) Pub. Date: Mar. 5, 2026

(54) CONVERSATIONAL AVATAR SYSTEM

(71) Applicant: 2wai Inc., Bal Harbour, FL (US)

(72) Inventors: Russell Geyser, Los Angeles, CA (US); Alex Finden, Encinitas, CA (US); Mason Geyser, West Hills, CA (US); Jonathan Knapper, Aberdeen (GB); James Robert Pyers, New River, AZ (US); Gary Shoefield, Beverly Hills, CA (US); Calum David Webster Worthy, Victoria (CA)

(73) Assignee: 2wai Inc., Bal Harbour, FL (US)

(21) Appl. No.: 19/319,046

(22) Filed: Sep. 4, 2025

Related U.S. Application Data
(60) Provisional application No. 63/690,372, filed on Sep. 4, 2024.
(60) Provisional application No. 63/804,946, filed on May 13, 2025.

(51) Int. Cl. G06T 13/40

(52) U.S. Cl. CPC G06T 13/40

(57) ABSTRACT

Systems and methods for conversational avatar systems are disclosed herein. The systems and methods may include receiving, via a computing system, an input comprising speech data; generating, via the computing system, a transcript of the speech data in real-time; analyzing, via the computing system, the transcript in real-time; generating, via the computing system, a response to the transcript in real-time based on the tagging; selecting, via the computing system, one or more avatar animation gestures based on tone and speech patterns of the generated response; synthesizing, via the computing system, an audible response based on the generated response; synchronizing, via the computing system, the one or more avatar animation gestures to the synthesized audible response to form a synchronized avatar animation; and rendering, via the computing system, the synchronized avatar animation.

### CROSS-REFERENCE TO RELATED APPLICATIONS

This application claims priority to U.S. Provisional Application No. 63/690,372, filed Sep. 4, 2024, and U.S. Provisional Application No. 63/804,946, filed May 13, 2025, which are hereby incorporated by reference in their entireties.

### FIELD

The present disclosure is generally directed to systems and methods for conversational avatar systems.

### BACKGROUND

In recent years, there have been an increased number of Artificial Intelligence (AI) assistants. These are mainly focused on voice interaction with limited transcription capabilities. Additionally, the current transcription systems lack the ability to be integrated into an advanced conversational AI and are limited in context awareness.

### SUMMARY

In some embodiments, a method is provided. The method may include receiving, via a computing system, an input comprising speech data. The method may further include generating, via the computing system, a transcript of the speech data in real-time. The method may further include analyzing, via the computing system, the transcript in real-time. The analyzing may include tagging one or more portions of the transcript based on one or more of conversation context, sentiment, and engagement. The method may further include generating, via the computing system, a response to the transcript in real-time based on the tagging. The method may further include selecting, via the computing system, one or more avatar animation gestures based on tone and speech patterns of the generated response. The method may further include synthesizing, via the computing system, an audible response based on the generated response. The method may further include synchronizing, via the computing system, the one or more avatar animation gestures to the synthesized audible response to form a synchronized avatar animation. The method may further include rendering, via the computing system, the synchronized avatar animation.

In some embodiments, a system is provided. The system may include a non-transitory storage medium storing computer program instructions and a processor configured to execute the computer program instructions to cause operations. The operations may include receiving, via a computing system, an input comprising speech data. The operations may further include generating, via the computing system, a transcript of the speech data in real-time. The operations may further include analyzing, via the computing system, the transcript in real-time. The analyzing may include tagging one or more portions of the transcript based on one or more of conversation context, sentiment, and engagement. The operations may further include generating, via the computing system, a response to the transcript in real-time based on the tagging. The operations may further include selecting, via the computing system, one or more avatar animation gestures based on tone and speech patterns of the generated response. The operations may further include synthesizing, via the computing system, an audible response based on the generated response. The operations may further include synchronizing, via the computing system, the one or more avatar animation gestures to the synthesized audible response to form a synchronized avatar animation. The operations may further include rendering, via the computing system, the synchronized avatar animation.

In some embodiments, a non-transitory storage medium storing computer program instructions is provided. The computer program instructions when executed may cause a computing system to perform operations. The operations may include receiving, via a computing system, an input comprising speech data. The operations may further include generating, via the computing system, a transcript of the speech data in real-time. The operations may further include analyzing, via the computing system, the transcript in real-time. The analyzing may include tagging one or more portions of the transcript based on one or more of conversation context, sentiment, and engagement. The operations may further include generating, via the computing system, a response to the transcript in real-time based on the tagging. The operations may further include selecting, via the computing system, one or more avatar animation gestures based on tone and speech patterns of the generated response. The operations may further include synthesizing, via the computing system, an audible response based on the generated response. The operations may further include synchronizing, via the computing system, the one or more avatar animation gestures to the synthesized audible response to form a synchronized avatar animation. The operations may further include rendering, via the computing system, the synchronized avatar animation.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 depicts a block diagram of an illustrative computing environment, in accordance with example embodiments.

FIG. 2 depicts a block diagram of illustrative modules, in accordance with example embodiments.

FIG. 3 depicts a diagram of an illustrative interaction capture module, in accordance with example embodiments.

FIG. 4 depicts a diagram of an illustrative speech processing module, in accordance with example embodiments.

FIG. 5 depicts a diagram of an illustrative conversation management module, in accordance with example embodiments.

FIG. 6 depicts a diagram of an illustrative avatar intelligence module, in accordance with example embodiments.

FIG. 7 depicts a diagram of an illustrative domain processing module, in accordance with example embodiments.

FIG. 8 depicts a diagram of an illustrative data analytics module, in accordance with example embodiments.

FIG. 9 depicts a diagram of an illustrative avatar response module, in accordance with example embodiments.

FIG. 10 depicts a diagram of an illustrative use case applications module, in accordance with example embodiments.

FIG. 11 depicts a diagram of security and compliance module, in accordance with example embodiments.

FIG. 12 depicts a flowchart of an illustrative method, in accordance with example embodiments.

FIG. 13 depicts a block diagram of an example computing device, in accordance with example embodiments.

FIG. 14 is a block diagram illustrating lip-sync module, according to example embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The present disclosure is generally directed to systems and methods for user-generated holographic avatars. In particular, the present disclosure is directed to generating holographic avatars based on individual users and deploying the holographic avatars in various settings. Embodiments can include a method of generating and deploying holographic avatars. Embodiments can include a system for generating secure holographic avatars.

While conventional AI assistants may provide basic voice interaction and speech recognition, there is a lack of immersive, context-aware, avatar-based systems that can autonomously converse and provide real-time transcribed data with domain-specific intelligence. Existing transcription services fail to integrate multimodal data or adapt in real-time to user emotion, context, and tone. Healthcare and legal transcription tools are often siloed, static, or limited by licensing or customization constraints.

The present disclosure may enable two-way interactions between avatars, humans, and machines via a neural avatar interaction model. The avatars may operate autonomously, be guided by a moderator (human or AI), and/or adapt to contextual cues during interactions. Conversations may be transcribed in real-time using speech-to-text systems with semantic tagging, emotion recognition, and domain-specific annotation. The real-time transcription of the conversation along with the ability to generate a response in real-time may provide for a minimal delay in the avatar's response, approximating a normal conversation speed, which may provide a sense of normalcy to a user. The present system may support AI-driven diagnostic and learning applications with secure data handling, privacy compliance (HIPAA and/or GDPR, for example), and blockchain-based verification.

The present disclosure relates to systems and methods for generating, managing, and deploying AI-driven holographic avatars capable of real-time, emotionally responsive interactions across multiple platforms. These avatars may be created using captured user input—such as video, audio, or behavioral cues—and may be enhanced through machine learning to adapt, personalize, and continuously improve based on context and/or user feedback.

The system may include a modular architecture including one or more of an avatar generation module, a conversation management module, an avatar intelligence module, a voice generation engine, a data analytics framework, or a comprehensive security and compliance module. Machine learning techniques, including supervised and/or adaptive learning, may enable sentiment-aware and domain-specific avatar responses. The conversation management module may incorporate one or more of natural language understanding, interaction memory, context modeling, or real-time response handling to deliver natural, coherent dialogue.

An avatar intelligence module may coordinate sentiment analysis, adaptive response modeling, and domain-based behavior tuning, such as for healthcare, education, or customer support. Speech synthesis may be performed using text-to-speech models that adapt in real-time to emotional tone, clarity needs, and cultural preferences.

Security and privacy may be maintained through a federated learning-compatible architecture that may include data anonymization, regulatory compliance modules, blockchain-based authentication and audit trails, access control, and user-managed data ownership. Transcripts and behavioral data may be hashed and stored or referenced on-chain for integrity, traceability, and rights enforcement.

Avatars may be configured to be deployed across web, mobile, and AR/VR environments using cross-platform integration and developer API kits. The system may be configured to support real-time interactions at human-like speeds, delivering naturalistic and personalized engagement for use cases including, for example, one or more of virtual assistants, education, healthcare, entertainment, or enterprise communication.

As used herein, real-time may encompass near real-time. For example, a recitation of a real-time response may encompass a near real-time response.

Techniques disclosed herein described with respect to cloud-based environments can be performed on edge components, such as a mobile device, in conjunction with or separate from cloud-based environments.

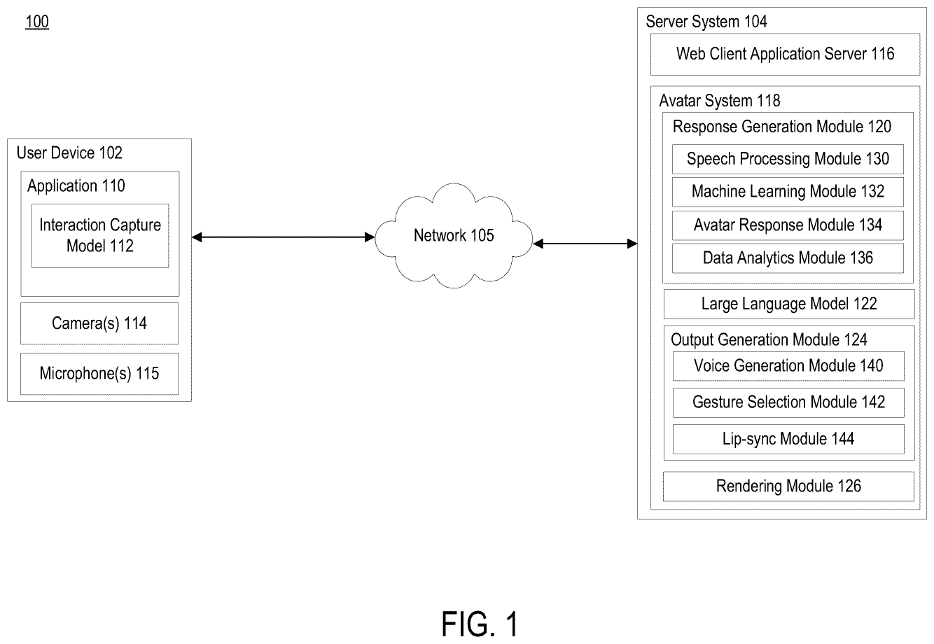

FIG. 1 is a block diagram of an illustrative computing environment 100, in accordance with example embodiments. Computing environment 100 may include user device 102 and server system 104 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be the Internet, a private data network, virtual private network using a public network and/or other suitable connection(s) that enables components in computing environment 100 to send and receive information between the components of computing environment 100.

User device 102 may be operated by a user. User device 102 may be representative of a mobile device, a tablet, a desktop computer, or any computing system having the capabilities described herein. User device 102 may include an application 110 executing thereon. Application 110 may be representative of an application associated with server system 104. For example, application 110 may be representative of an application that allows an avatar-human, avatar-avatar, and/or avatar-machine conversation, and captures at least one of visual and audio data of the user for use in the conversation. In some embodiments, application 110 may be a standalone application associated with server system 104, such as a mobile application, tablet application, desktop application, or, more generally, a software application affiliated with an entity associated with server system 104. In some embodiments, application 110 may be representative of a web browser configured to communicate with server system 104, such that an end user may gain access to avatar system 118 of server system 104 via a web browser. More generally, application 110 may be configured to provide an interface between user device 102 and server system 104 for the purpose of allowing a user to access functionality of the avatar system of server system 104. Via application 110, a user can converse with avatar system 118, which can provide real-time responses to the user with appropriate sentiment and tone of voice based on the user's perceived sentiment and tone of voice.

Application 110 may include interaction capture module 112. Interaction capture module 112 may include one or more software modules. The one or more software modules may be collections of code, or instructions stored on a media (e.g., memory of user device 102) that represent a series of machine instructions (e.g., program code) that implements one or more algorithmic steps. The machine instructions may be the actual computer code the processor of user device 102 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions. Interaction capture module 112 may be configured to interface with one or more cameras 114 and one or more microphones 115 of user device 102 to capture a video and audio of the user during the conversation.

Server system 104 may be representative of one or more servers configured to communicate with one or more user devices, such as user device 102. Server system 104 may include web client application server 116 and avatar system 118. Avatar system 118 may be configured to manage avatars and converse with end users using one or more avatars. As shown, avatar system 118 may include response generation module 120, large language model 122, output generation module 124, and rendering module 126. Each of response generation module 120, large language model 122, output generation module 124, and rendering module 126 may include one or more software modules. The one or more software modules may be collections of code, or instructions stored on a media (e.g., memory of server system 104) that represent a series of machine instructions (e.g., program code) that implements one or more algorithmic steps. The machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Response generation module 120 may be configured to respond in real-time to a user query captured via application 110. As used herein, a query may include any question, prompt, and/or statement made by a user and/or machine to be input for a response by avatar system 118. Response generation module 120 may include speech processing module 130, machine learning module 132, avatar response module 134, and data analytics module 136.

Speech processing module 130 may be configured to receive the audio generated by interaction capture module 112 at user device 102. Speech processing module 130 may include one or more algorithms for removing noise from the uploaded audio. By removing the noise from the uploaded audio, speech processing module 130 may effectively isolate the user's voice within the audio, which may assist in differentiating which speaker is speaking and in generating a transcript of the conversation.

Machine learning module 132 may be configured to adapt a generated response based on perceived user feedback, such as a perceived sentiment and/or tone of voice of the user. The machine learning model implemented by machine learning module 132 may be trained to adapt a generated response based on perceived user feedback. In some embodiments, the training process is a supervised training process in which the machine learning model is trained to adapt a generated response on perceived user feedback based on a training data set that includes example sentiment tags and a corresponding sentiment response. Through this process, the machine learning model learns relationships between the input data (e.g., user sentiment) and the output data (e.g., adapted response). The training process may continue until the machine learning model reaches a threshold level of accuracy.

In some embodiments, the training process may include one or more unsupervised learning or reinforcement learning techniques. Unsupervised learning may be used to discover latent emotional and/or behavioral patterns from user inputs. Reinforcement learning may be used for real-time optimization of avatar response effectiveness based on ongoing user interactions and feedback. The optimization may enhance personalization of the avatar and adaptability of the avatar to different circumstances.

Machine learning module 132 may be configured to determine which domain is most appropriate for a conversation based on the transcript of the conversation. As used herein, domain may denote a specific sphere of activity or knowledge, for example, a legal domain, a medical domain, or a customer service domain. The machine learning model implemented by machine learning module 132 may be trained to determine which domain is most appropriate based on a training process. In some embodiments, the training process is a supervised training process in which the machine learning model is trained to determine which domain is most appropriate based on a training data set that includes example words and/or phrases and their corresponding domain, such as medical domain. Through this process, the machine learning model may learn relationships between the input data (e.g., words and/or phrases) and the output data (e.g., domain). The training process may continue until the machine learning model reaches a threshold level of accuracy.

Avatar response module 134 may be configured to generate a response based on a transcript of the conversation. Avatar response module 134 may be configured to use one or more of machine learning module 132 or large language model 122 in generating and/or adapting the response. Avatar response module 134 may be configured to receive an interaction context based on captured gesture information and facial expressions of a user along with a natural language understanding of the output of speech processing module 130. The natural language understanding may include sentiment tags and indications of the user's tone of voice. Avatar response module 134 may be configured to generate a response in real-time such that the conversation can be at a speed approximating a normal conversation speed.

In some embodiments, avatar response module 134 may generate a response to a prompt directed towards the avatar by interfacing with large language model 122. Large language model 122 may be representative of one or more large language models affiliated with server system 104 or external to server system 104 (e.g., ChatGPT, Claude, Llama, etc.). In operation, response generation module 120 may receive a prompt directed to the avatar. In some embodiments, the prompt may be a voice prompt. In the case that the prompt is a voice prompt, speech processing module 130 may convert the audio into a text-based format and may provide the text of the audio to large language model 122 for a response generation. For example, the text of the audio may act as the prompt to large language model 122 for generating an output. In some embodiments, response generation module 120 may provide additional context to large language model 122 to conform the output to perceived user sentiment. In some embodiments, large language model 122 may be able to handle a variety of language inputs and generate, as output, a variety of language outputs.

Data analytics module 136 may be configured to analyze the transcript based on the domain tagging. Data analytics module 136 may be configured to provide sentiment insights including emotion and intent detection and a real-time analysis. The real-time analysis may be based on an automatic summary of the transcript and identified action items. Data analytics module 136 may be configured to analyze conversational data for detection of medical, legal, and/or training-related issues, among other issues. In some embodiments, data analytics module 136 may provide a real-time analysis of the generated response to identify insights, summarize content, and extract action items.

As output from response generation module 120, output generation module 124 may receive a generated response to be conveyed by an avatar. In some embodiments, the avatar and the output intended to be conveyed by the avatar may be rendered at user device 102. In some embodiments, the avatar and the output intended to be conveyed by the avatar may be rendered at server system 104 and transmitted to user device 102 for display.

Output generation module 124 may include voice generation module 140, gesture selection module 142, and lip-sync module 144.

Voice generation module 140 may be configured to synthesize speech based on the generated response. Voice generation module 140 may use one or more text-to-speech models. For example, in some embodiments, voice generation module 140 may use one or more of Wav2Lip, Deepgram, Tacotron, FastSpeech, or a custom-trained text-to-speech engine. Voice generation module 140 may be configured to adapt speech characteristics in real-time based on user feedback to enhance one or more of clarity, emotion, cultural nuances, and/or the like.

Gesture selection module 142 may be configured to select one or more gestures from a library of gestures based on the corresponding generated response. In some embodiments, gesture selection module 142 may use a machine learning model to determine which gestures to select. Gesture selection module 142 may be configured to dynamically adapt body language of the avatar based on the flow of the conversation.

Lip-sync module 144 may be configured to animate the avatar and synchronize the lips and gestures with the synthesized speech such that the avatar may appear to be speaking naturally. Lip-sync module 144 may be configured to integrate the gestures and facial movements such that the gestures and facial movements transition seamlessly while the avatar is speaking. In some embodiments, output generation module 124 may be configured to integrate a patch generated by lip-sync module 144 onto a head of an avatar.

In some embodiments, lip-sync module 144 may use the Wav2Lip framework as a foundation to animate the lips of the avatar based on the output generated by response generation module 120 and/or large language model 122. In some embodiments, Wav2Lip may be customized for real-time generation process. In some embodiments, the process may include input processing in which lip-sync module 144 may take the generated audio (speech) and the avatar's facial expressions as inputs. Lip-sync module 144 may utilize the Wav2Lip model to extract relevant features from both the audio and video inputs. Based on the audio features, Wav2Lip may predict the corresponding lip movements. Based on the real-time customizations, Wav2Lip may process the output in real-time to reduce latency and improve the overall efficiency of the system. Lip-sync module 144 may then apply the predicted lip movements to the avatar's face, creating a synchronized video output. In some embodiments, lip-sync module 144 may fine-tune the output by making continuous adjustments to ensure smooth and natural-looking lip movements that match the audio precisely. This approach may allow for highly accurate and responsive lip-syncing, crucial for creating believable and engaging avatar interactions in real-time applications.

Rendering module 126 may be configured to communicate a rendering of the avatar to user device 102 to enable user device 102 to render the avatar. In some embodiments, rendering module 126 may include one or more instructions generated based on output generation module 124. The instructions may be readable by user device 102 to enable user device 102 to render the generated, synchronized avatar. In some embodiments, rendering module 126 may be configured to render the avatar and the output intended to be conveyed by the avatar at server system 104 and transmit the rendering to user device 102 for display.

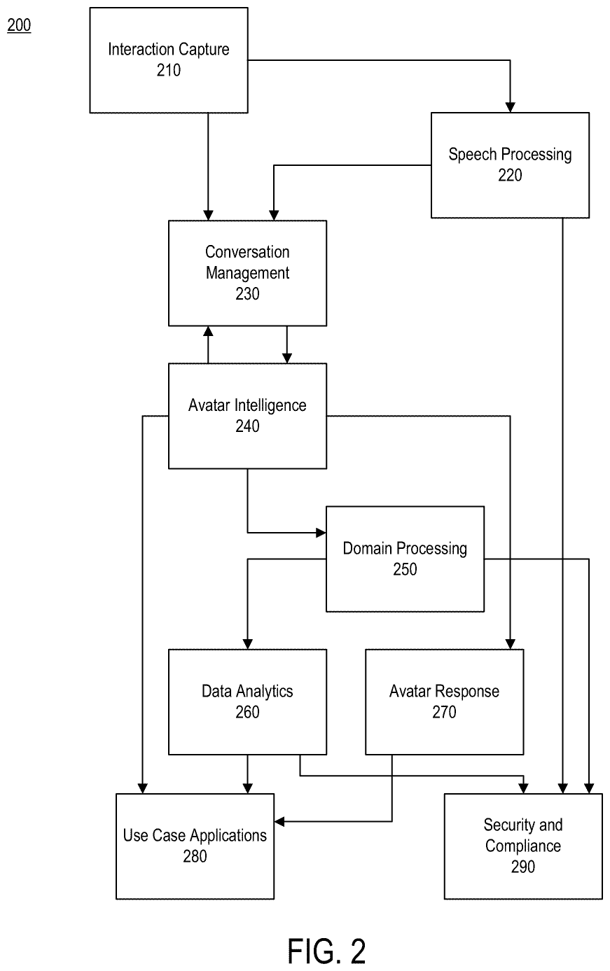

FIG. 2 is a block diagram of an illustrative computing environment 200, in accordance with example embodiments. Computing environment 200 may be utilized by avatar system 118. Interaction capture module 210 may be in communication with at least speech processing module 220 and conversation management module 230. Speech processing module 220 may be in communication with at least interaction capture module 210, conversation management module 230, and security and compliance module 290. Conversation management module 230 may be in communication with at least interaction capture module 210, speech processing module 220, and avatar intelligence module 240. Avatar intelligence module 240 may be in communication with at least conversation management module 230, domain processing module 250, avatar response module 270, and use case applications module 280. Domain processing module 250 may be in communication with at least avatar intelligence module 240, data analytics module 260, and security and compliance module 290. Data analytics module 260 may be in communication with at least domain processing module 250, use case applications module 280, and security and compliance module 290. Avatar response module 270 may be in communication with at least avatar intelligence module 240 and use case applications module 280. Use case applications module 280 may be in communication with at least avatar intelligence module 240, data analytics module 260, and avatar response module 270. Security and compliance module 290 may be in communication with at least speech processing module 220, domain processing module 250, and data analytics module 260. Communication between the modules is provided in more detail below.

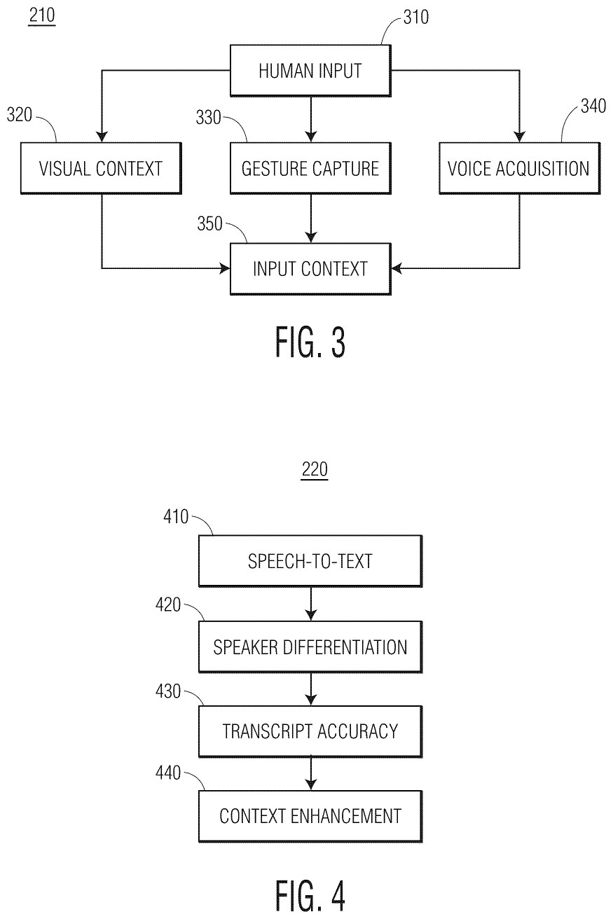

FIG. 3 is a diagram of an illustrative interaction capture module 210, in accordance with example embodiments. Interaction capture model 112 may utilize interaction capture module 210 to perform the process of capturing a user interaction as detailed below. The interaction capture module 210 may receive one or more user inputs 310. The one or more user inputs 310 may include one or more of visual context 320, gesture information 330, or voice information 340. Visual context 320 may be representative of visual perception of the user. For example, visual context 320 may include one or more of lip movements, facial expressions, or the like. Gesture information 330 may be representative of gestures performed by the user. Voice information 340 may be representative of speech produced by the user. Voice information 340 may be processed via speech processing module 220. The interaction capture module 210 may receive the one or more user inputs 310 via user device 102. The one or more user inputs 310 may be mapped together as an input context 350 such that at least gestures, voice, and lip movement may be coordinated. In some embodiments, one or more user inputs 310 may be tagged based on sentiment, or the like, to provide context to the one or more user inputs 310. Input context 350 may be integrated into conversation management module 230 via contextual integration 510.

FIG. 4 is a diagram of an illustrative speech processing module 220, in accordance with example embodiments. Speech processing module 220 may include a speech-to-text model 410, a speaker differentiation model 420, a transcript accuracy model 430, and a context enhancement model 440. Speech-to-text model 410 may be configured to receive voice information 340 and generate text based on the voice information 340 data. Speech-to-text model 410 may be configured to tag one or more portions of the text with one or more of semantic, emotion, or domain-specific annotations. In some embodiments, speech processing module 220 may be speech processing module 130.

Speaker differentiation model 420 may be configured to differentiate between speakers of the voice information 340 data in real-time. The speakers may be one or more of a human, a machine, or an AI avatar. For example, speaker differentiation model 420 may determine that Avatar A spoke in response to a query from Human A. Speech processing module 220 may be configured to filter out noise from recordings of speech to, for example, aid in identifying what is being said and who the speaker is.

Transcript accuracy model 430 may be configured to determine whether the generated transcript is accurate based on the conversation history. Based on the determination, context enhancement model 440 may be configured to enhance the transcript by correcting any perceived misinterpretations. The generated transcript may be communicated to conversation management module 230 for natural language understanding by natural language understanding model 520. Speech processing module 220 may be configured to communicate the generated transcript along with any enhancements to security and compliance module 290 for ensuring security of the transcript and tracking of the originally generated transcript and any enhancements.

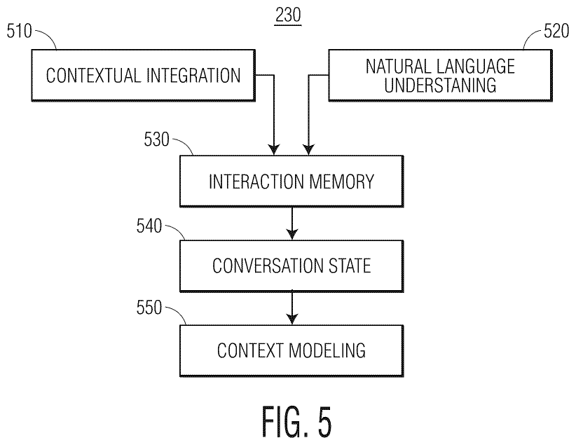

FIG. 5 is a diagram of an illustrative conversation management module 230, in accordance with example embodiments. The conversation management module 230 may include contextual integration 510, a natural language understanding model 520, an interaction memory 530, a conversation state 540, and context modeling 550. Contextual integration 510 may be configured to integrate the context input via interaction capture module 210 in order to appropriately respond to the user's input. Interaction memory 530 may be configured to store a memory of interactions based on integrated context and natural language understanding of the transcript of the conversation. Conversation state 540 may be configured to determine a conversation state based on the memory of the conversation including the latest transcript and context. Context modeling 550 may be configured to model the inputs and determinations of conversation management module 230 to generate a complete context. Context modeling 550 may be configured to consolidate one or more of integrated user input, current and past conversational memory, conversation state, or semantic/intent tags. The integrated user input may include one or more of voice, gestures, or emotion of the user. Conversation management module 230 may be configured to communicate the context to avatar intelligence module 240.

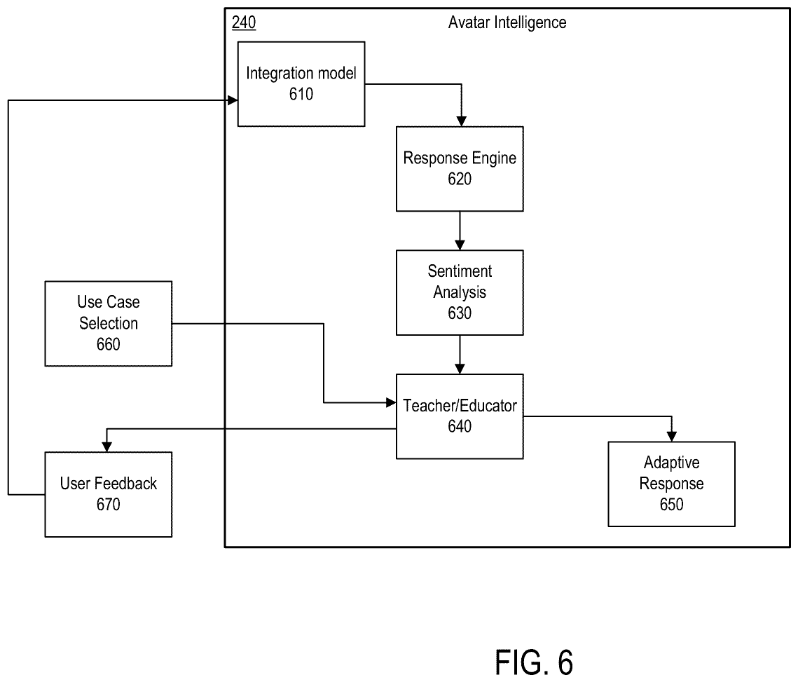

FIG. 6 is a diagram of an illustrative avatar intelligence module 240, in accordance with example embodiments. The avatar intelligence module 240 may include integration model 610, a response engine 620, a sentiment analysis 630, a teacher/educator model 640, and an adaptive response model 650. Integration model 610 may be configured to integrate context modeling 550 of conversation management module 230 and/or user feedback communicated from user feedback model 670 into avatar intelligence module 240. Response engine 620 may be configured to generate a response based on the integration. In some embodiments, response engine 620 may be configured to utilize machine learning module 132 in generating a response to the conversation transcript. Sentiment analysis 630 may be configured to analyze sentiment of at least one of the generated response, the transcript, and/or user feedback. Sentiment analysis 630 may enable avatar intelligence module 240 to adapt a response based on an interaction with a user. For example, based on a user's perceived behavior, the avatar may determine a sentiment of the user and adjust a response, including tone of voice, to the determined sentiment. Teacher/Educator model 640 may be configured to teach avatar intelligence module 240 based on a use case selection communicated from use case selector model 660. In some embodiments, teacher/educator model 640 may utilize machine learning module 132 to continue learning based on use case selector model 660. The integration with machine learning module 132 may provide domain-aligned response refinement and personalization over time. Teacher/educator model 640 may be configured to provide use case-specific tuning based on one or more of the domains, such as education, support, emergency response, legal, and/or medical. Teacher/educator model 640 may be configured for continuous learning informed by real-time interaction feedback via use case selector model 660 and/or user feedback model 670. Adaptive response model 650 may be configured to adapt the generated response based on at least one of the sentiment and/or the use case selection. Avatar intelligence module 240 may be configured to communicate the adapted response to at least one of avatar response module 270 or domain processing module 250. Avatar intelligence module 240 may be configured to execute in real-time such that the avatar may respond to a query from a user with a minimal delay, approximate a normal conversation speed.

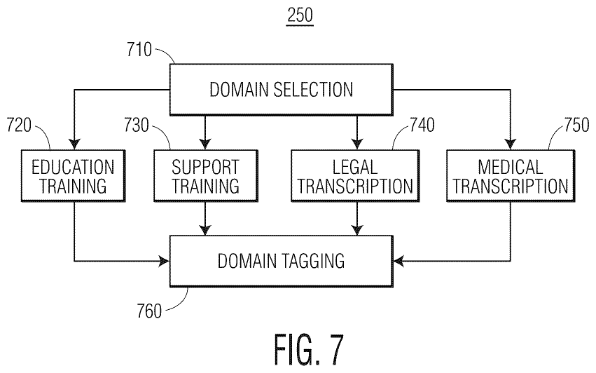

FIG. 7 is a diagram of an illustrative domain processing module 250, in accordance with example embodiments. The domain processing module 250 may include a domain selection model 710 and a domain tagging model 760. The domain selection model 710 may be configured to determine the appropriate domain for one or more of the transcript and/or the adapted response from avatar intelligence module 240. The domains may be representative of one or more of education training 720, support training 730, legal transcription 740, and/or medical transcription 750.

Based on which domain is appropriate, domain tagging model 760 may tag the transcript and/or response according to the appropriate domain. For example, domain tagging model 760 may be configured to automatically tag medical terminology in the transcript and/or response based on selection of medical transcription 750. As a further example, domain tagging model 760 may be configured to format the transcript and/or response for one or more legal uses based on selection of legal transcription 740. As a further example, domain processing module 250 may be configured to process the transcript and/or response to evaluate training for customer service, along with agent performance and response accuracy, and summarize the transcript and/or response based on selection of support training 730. Domain processing module 250 may be configured to provide real-time diagnostics of the appropriate domain such that it may be able to recognize, for example, mental health cues, legal inconsistencies, and the like. Domain processing module 250 may be configured to communicate the resulting domain tagged transcript and/or response to one or more of security and compliance module 290 or data analytics module 260.

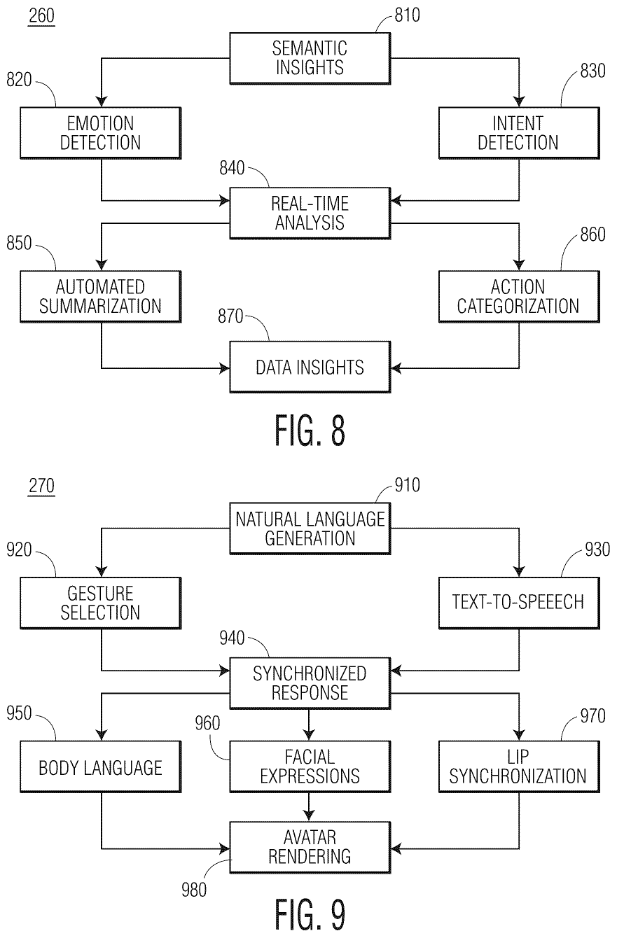

FIG. 8 is a diagram of an illustrative data analytics module 260, in accordance with example embodiments. Data analytics module 260 may be configured to generate semantic insights 810, real-time analysis 840, and data insights 870. In some embodiments, data analytics module 260 may be data analytics module 136. Semantic insights 810 may be configured to detect emotion 820 and detect intent 830. Real-time analysis 840 may be configured to automatically summarize 850 conversation history and distill the conversation into action points via action categorization 860. Data insights 870 may be generated based on the semantic insights 810 and real-time analysis 840. Data analytics module 260 may communicate data insights 870 to one or more of use case applications module 280 or security and compliance module 290 for data anonymization 1110.

FIG. 9 is a diagram of an illustrative avatar response module 270, in accordance with example embodiments. The avatar response module 270 may include a natural language generation model 910, a gesture selection model 920, a text-to-speech model 930, a synchronized response model 940, and an avatar rendering model 980. Natural language generation model 910 may be configured to generate a natural language response based on a generated and/or adapted response from avatar intelligence module 240. Natural language generation model 910 may utilize avatar response module 134 to generate the natural language response. Avatar response module 270 may use gesture selection model 920 to select gestures from a library of gestures stored in a memory of server system 104 and may use text-to-speech model 930 to synthesize speech from the natural language response and/or the generated response. Avatar response module 270 may utilize output generation module 124 to select gestures and synthesize speech. Synchronized response model 940 may be configured to synchronize one or more of body language 950, facial expression 960, and lip movements 970 based on the selected gestures and the synthesized speech. Synchronized response model 940 may utilize output generation module 124 in synchronizing the body language, facial expressions, and lip movements with the speech. Avatar response module 270 may be configured to render an avatar via user device 102 using the synchronized response information such that the avatar appears to be speaking the audible response generated from the synthesized speech and appears to be making gestures and/or expressions appropriate given the generated response. Avatar response module 270 may utilize rendering module 126 in rendering the avatar. Avatar response module 270 may be configured to execute in real-time such that the avatar may respond to a query from a user with a minimal delay, approximate a normal conversation speed.

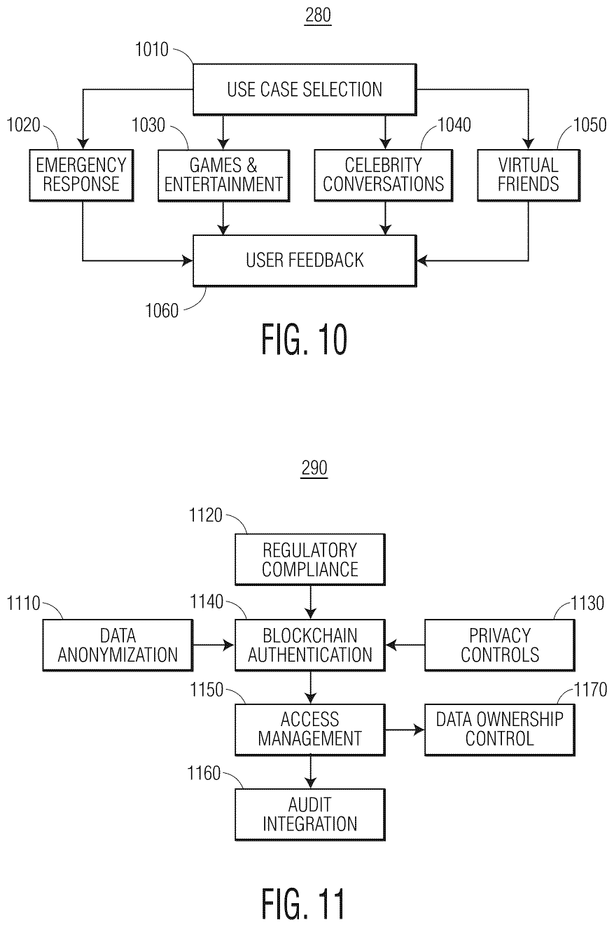

FIG. 10 is a diagram of an illustrative use case applications module 280, in accordance with example embodiments. The use case applications module 280 may include a use case selector model 660 and a user feedback model 670. The use case selector model 660 may be configured to select between one or more of an emergency response use case 1020, a games and entertainment use case 1030, a celebrity conversation use case 1040, or a virtual friends use case 1050. The user feedback model 670 may be configured to receive the selected use case from use case selector model 660 and communicate the use case to avatar intelligence module 240. For example, use case selector model 660 may be configured to perceive that the transcript includes a sense of urgency, such as signs of distress, legal urgency, and/or medical emergencies, and may select emergency response use case 1020. As an example of the legal urgency use case, the response generation module 120 may provide a legal assistance avatar which may be configured to transcribe and analyze the conversation for real-time legal consultation. A determination of requiring an emergency response may be communicated from use case applications module 280 to avatar intelligence module 240 such that avatar intelligence module 240 may adapt its responses to the situation.

FIG. 11 is a diagram of security and compliance module 290, in accordance with example embodiments. The security and compliance module 290 may include data anonymization 1110, regulatory compliance 1120, privacy controls 1130, blockchain authentication 1140, access management 1150, integration auditing 1160, and data ownership control 1170.

The data anonymization 1110 may be configured to anonymize the received data such that it may be used in federated learning. For example, data insights 870 regarding a generated response along with user feedback may be received by data anonymization 1110 and anonymized. The machine learning module 132 may be configured to improve the AI model(s) using the anonymized data. The improvements may then be communicated to a cloud-based AI model via network 105 to improve it without sharing any of the anonymized data from the device.

Regulatory compliance 1120 may be configured to ensure compliance with data privacy requirements, such as HIPAA, GDPR, and the like. Regulatory compliance 1120 may receive the domain tagged transcript and/or response from domain processing module 250 to ensure compliance of the transcript and/or response with data privacy requirements. Privacy controls 1130 may include one or more controls for controlling privacy of components of avatar system 118, such as the transcript of the conversation. In some embodiments, privacy controls 1130 may include redacting sensitive information. Regulatory compliance 1120 may be configured to identify sensitive information by analyzing the model input and/or output by inference in a secure enclave. Regulatory compliance 1120 may be configured to provide signed and queryable audit trails of the redactions performed by privacy controls 1130. In some embodiments, regulatory compliance 1120 may use an allow list for clinical terminology while masking identifiers such that only what needs to be redacted is redacted. The audit logs may be hashed and inserted in a public ledger and/or blockchain. In some embodiments, regulatory compliance 1120 may be configured to transmit a trusted execution environment attestation to show the trustworthiness of the redactions.

Blockchain authentication 1140 may be configured to receive transcripts generated from the conversation via communication with speech processing module 220 and insert the transcripts into a blockchain. In some embodiments, the transcripts may be inserted into the same blockchain as the audit logs such that they are tied to the audit logs. Any enhancements made to the transcripts by speech processing module 220 and/or security and compliance module 290 may be added to a blockchain as well in order to track any changes, including redactions, made to the original transcript. Such blockchain tracking may ensure the integrity of conversation transcripts and their edits. Blockchain authentication 1140 may be configured to track access control such that those without appropriate access rights would be unable to access the data.

Access management 1150 may be configured to reference blockchain authentication 1140 in managing access based on who has access rights. Integration auditing 1160 may be configured to audit the integration of the avatar in various settings to ensure privacy and regulatory compliance.

Data ownership control 1170 may be configured to provide ownership control of the avatar. Ownership control may include the right to grant, revoke, and/or restrict access to the data at any time. Data ownership control 1170 may be configured to ensure that the owner maintains explicit ownership rights over their personal data, including one or more transcripts, audio inputs, avatar behavior metadata, or any derived insights. Ownership rights may be recorded and enforced using blockchain authentication 1140 to ensure verifiable and tamper-proof tracking of data provenance and permissions. In some embodiments, data ownership control 1170 may support exportability of the avatar. Data ownership control 1170 may be configured to enable users to retrieve and transfer their data in compliance with data portability regulations based on regulatory compliance 1120.

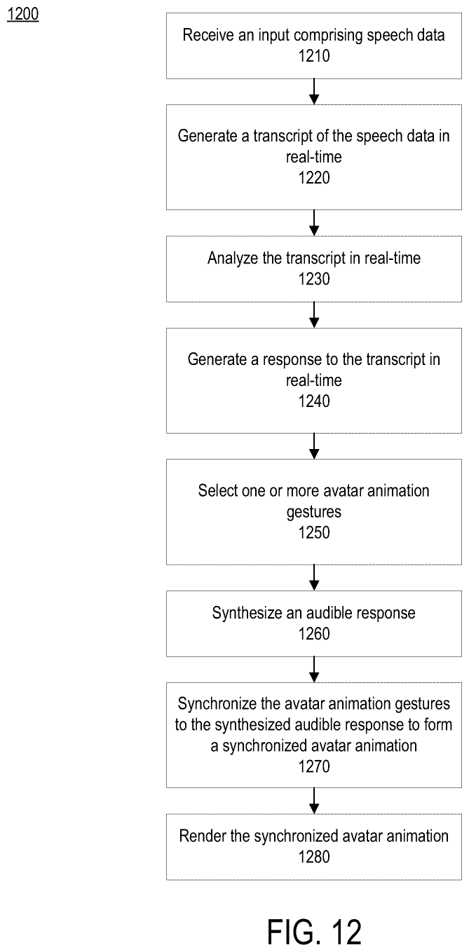

FIG. 12 is a flowchart illustrating a method 1200, according to example embodiments. Method 1200 may begin at step 1210.

At step 1210, a computing system may receive an input including speech data. The speech data may include a recording of a user speaking and/or synthesized speech from a separate AI model, as the conversation may be avatar-to-avatar, avatar-to-human, and/or avatar-to-machine. In some embodiments, the speech data may include data from one or more users and one or more separate AI models. The AI models may control avatars similar to the avatar described in the present disclosure.

At step 1220, the computing system may generate a transcript of the speech data in real-time. The computing system may differentiate between multiple speakers. For example, in generating the transcript, the computing system may determine that Avatar A spoke in response to a query from Human A. The computing system may be configured to input the transcript into a blockchain via security and compliance module 290. In some embodiments, the first transcript of a conversation may be input to a genesis block such that each conversation has its own blockchain to govern access to each conversation separately. The computing system may be configured to enhance the transcript by reviewing the conversation history and correcting the transcript based on the review of the conversation history. The enhancements may aid to correct any misinterpretations of the computing system such that the computing system may correctly understand the context of conversations while providing responses.

At step 1230, the computing system may analyze the transcript in real-time. The computing system may analyze the transcript by tagging one or more portions of the transcript based on one or more of conversation context, sentiment, and/or engagement of the user. Based on the analysis of the transcript, an appropriate domain may be selected to aid the avatar system in understanding the user and generating responses. The domain may be one or more of a legal domain, a medical domain, and a customer support domain. The medical domain may prompt the avatar system to automatically tag medical terminology. The legal domain may prompt the avatar system to format the transcript for one or more legal purposes. The customer service domain may prompt the avatar system to evaluate at least one of training, agent performance, and response accuracy.

At step 1240, the computing system may generate a response to the transcript in real-time. The computing system may generate the response based on the tagging of portions of the transcript. The computing system may be configured to adapt at least one of tone, language complexity, or sentiment of the response based on user engagement. Machine learning module 132 may be trained to adapt the response based on user engagement.

At step 1250, the computing system may select one or more avatar animation gestures. The computing system may select the avatar animation gestures based on at least one of tone or speech patterns of the generated response. Gesture selection module 142 may select the avatar animations to correspond to the generated response.

At step 1260, the computing system may synthesize an audible response based on the generated response. In some embodiments, the voice generation module 140 may synthesize the audible response. The computer system may be configured to adapt the audible response in real-time based on user feedback. For example, if avatar system 118 perceives that the user is not understanding the audible response, avatar system 118 may adjust one or more speech characteristics to enhance one or more of speech clarity, emotion, and/or cultural nuances.

At step 1270, the computing system may synchronize the avatar animation gestures to the synthesized audible response to form a synchronized avatar animation. Lip-sync module 144 may synchronize the gestures, facial expressions, and audible response in synchronizing the avatar animation.

At step 1280, the computing system may render the synchronized avatar animation. Rendering module 126 may prepare the synchronized avatar animation for rendering and communicate instructions to user device 102 for rendering the avatar. As used herein, rendering may include preparing an avatar for rendering, generating instructions for rendering an avatar, and/or executing instructions to render the avatar.

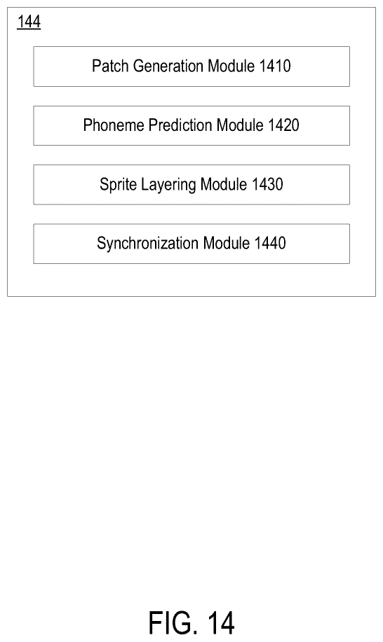

FIG. 14 is a block diagram illustrating lip-sync module 144, according to example embodiments. Lip-sync module 144 may include one or more of a patch generation module 1410, a phoneme prediction module 1420, a sprite layering module 1430, or a synchronization module 1440. Each of patch generation module 1410, phoneme prediction module 1420, sprite layering module 1430, and synchronization module 1440 may include one or more software modules. The one or more software modules may be collections of code, or instructions stored on a media (e.g., memory of server system 104) that represent a series of machine instructions (e.g., program code) that implements one or more algorithmic steps. The machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Patch generation module 1410 may be configured to generate a patch for avatar system 118. Patch generation module 1410 may be configured to generate a patch of an avatar's mouth for lip-sync module 144. Patch generation module 1410 may be configured to interface with avatar capture module 112 to receive a mouth region from video information of the user captured by one or more cameras 114. The extracted mouth region may be correlated with audio captured of the user by avatar capture module 112. Patch generation module 1410 may configured to interface with machine learning module 132. Machine learning module 132 may be configured to train patch generation module 1410 on how a user's mouth region moves when they speak. In some embodiments, patch generation module 1410 may be trained on how the user's mouth region moves for various phonemes. For example, for some phonemes, the tongue may be used in articulating the phoneme. As a further example, a user's teeth may show more for certain phonemes than for other phonemes. Patch generation module 1410 may be configured to generate a patch based on the user's lip movement.

In some embodiments, patch generation module 1410 may be configured to generate lip motion using a micro-codec. The micro-codec may be a blendshape micro-codec. The patch of the mouth region may be a blendshape base which may be driven from audio using one or more blendshape coefficients in real-time or near real-time. As an example, patch generation module 1410 may be configured to render a patch in less than about 10 ms. The one or more blendshape coefficients may be generated based on phoneme information of a generated avatar response. Using a micro-codec may provide adaptive streaming or storage of the patch with minimal overhead.

In some embodiments, patch generation module 1410 may be configured to generate lip motion using temporal diffusion. Patch generation module 1410 may include a tiny diffusion model. The tiny diffusion model may be trained on samples of the video and/or audio of the user. In some embodiments, the tiny diffusion model may be conditioned based on one or more of an identity embedding based on the face of the user, a phoneme embedding based on the voice of the user, a previous latent embedding for temporal coherence, or a noise schedule token to improve the tiny diffusion model. Patch generation module 1410 may be configured to interface with phoneme prediction module 1420 to receive a phoneme prediction. Patch generation module 1410 may be configured to execute diffusion steps to synthesize a patch based on predicted phonemes during runtime generation. This may provide a real-time or near-real time rendering of the patch. In some embodiments, the personalized tiny diffusion model one or more micro-movements to increase realism of the generated patch. For example, the one or more micro-movements may include moist lip speculars or teeth glints. The tiny diffusion model may provide a highly realistic and high quality patch for patch generation module 1410.

In some embodiments, patch generation module 1410 may be configured to generate lip motion using warp based on audio landmarks. One or more audio landmarks may be collected from the audio of the user processed by speech processing module 130. Patch generation module 1410 may include a tiny transformer configured to predict landmarks based on audio predictions from phoneme prediction module 1420. In some embodiments, patch generation module 1410 may include a convolutional neural network configured to warp a mouth frame of the user based on the neutral lip texture and the target landmark configuration. The convolutional neural network may be configured to provide smooth transitions between the landmarks. In some embodiments, patch generation module 1410 may include a thin-plate spline configured to warp a mouth frame of the user based on the neutral lip texture and the target landmark set. In some embodiments, patch generation module 1410 may provide micro-expressions, such as lip corner micro-motions to improve realism. Patch generation module 1410 may be configured to interface with sprite layering module 1430 to add one or more sprite layers of the tongue and/or the teeth for open mouth frames. The open mouth frames may be determined based on the phoneme class. In some embodiments, the phonemes may be predicted by phoneme prediction module 1420.

In some embodiments, patch generation module 1410 may be configured to select a method of generating the patch based on one or more constraints, such as latency constraints, processing constraints, quality requirements, or the like.

Phoneme prediction module 1420 may be configured to predict phonemes of a generated avatar response. In some embodiments, phoneme prediction module 1420 may look at least one frame or frame group ahead to predict a future phoneme in a response generated by large language model 122. The prediction may enable patch generation module 1410 to quickly generate a patch to provide real-time or near real-time speech.

Sprite layering module 1430 may be configured to provide one or more sprite layers to patch generation module 1410. The one or more sprite layers may include extracted tongue and/or teeth sprites from open mouth frames. The sprite layers may be based on phoneme class. For example, phonemes of /th/ and /l/ may require a tongue sprite layer while phonemes of /sh/ and /ch/ may require a teeth sprite layer. In some embodiments, the sprite layers may be based on user video/audio information. This may provide a more personalized patch if a user shows teeth, for example, for more phonemes than an average person. In some embodiments, sprite layering module 1430 may be configured to provide different sprite layers based on the openness of the mouth. For example, if the openness of the mouth is above a certain threshold for a phoneme, a specific sprite layer may be used.

Synchronization module 1440 may be configured to synchronize the lips with the audio phonemes such that the lips may appear to move naturally during speech. In some embodiments, synchronization module 1440 may be configured to synchronize the generated patch with one or more motions of the underlying avatar. Synchronization module 1440 may be configured to interface with output generation module 124. In some embodiments, synchronization module 1440 may be configured to interface with rendering module 126. Synchronization module 1440 may be configured to integrate the generated patch with the generated avatar. Synchronization module 1440 may be configured to match the skin tone of the patch with the skin tone of the avatar used by output generation module 124. In some embodiments, synchronization module 1440 may be configured to blend the edges of the patch to match the face of the avatar at the points of intersection between the patch and the face. Synchronization module 1440 may be configured to use shadow information to appropriately apply a shading correction to the patch. For example, if the avatar is in a shady environment, the patch should not appear that it is in full sun. The synchronization may provide improved realism in the speech and appearance of the avatar.

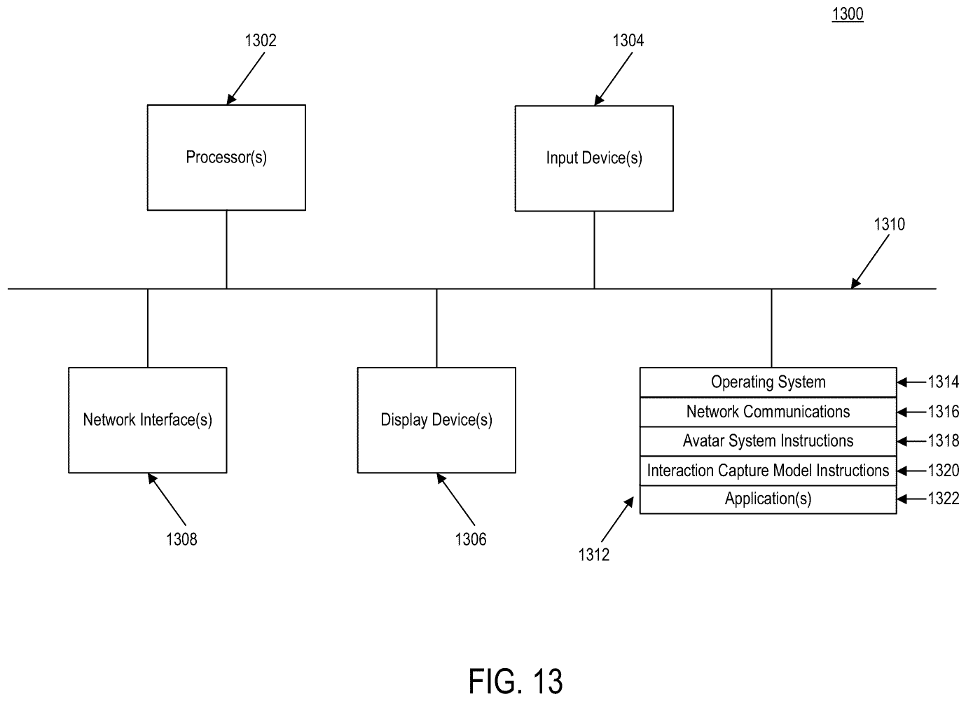

FIG. 13 shows a block diagram of an example computing device 1300 that implements various features and processes, according to example embodiments of this disclosure. For example, computing device 1300 may function as the server system 104 and/or the user device 102, or a portion or combination thereof in some embodiments. Additionally, the computing device 1300 may partially or wholly host and deploy avatar system 118. The computing device 1300 may also perform one or more steps of the method 1200. The computing device 1300 is implemented on any electronic device that runs software applications derived from compiled instructions, including without limitation personal computers, servers, smart phones, media players, electronic tablets, game consoles, email devices, etc. In some implementations, the computing device 1300 includes one or more processors 1302, one or more input devices 1304, one or more display devices 1306, one or more network interfaces 1308, and one or more computer-readable media 1312. Each of these components may be coupled by a bus 1310.

Display device 1306 includes any display technology, including but not limited to display devices using Liquid Crystal Display (LCD) or Light Emitting Diode (LED) technology. Processor(s) 1302 uses any processor technology, including but not limited to graphics processors and multi-core processors. Input device 1304 includes any known input device technology, including but not limited to a keyboard (including a virtual keyboard), mouse, track ball, and touch-sensitive pad or display. Bus 1310 includes any internal or external bus technology, including but not limited to ISA, EISA, PCI, PCI Express, USB, Serial ATA or FireWire. Computer-readable medium 1312 includes any non-transitory computer readable medium that provides instructions to processor(s) 1302 for execution, including without limitation, non-volatile storage media (e.g., optical disks, magnetic disks, flash drives, etc.), or volatile media (e.g., SDRAM, ROM, etc.).

Computer-readable medium 1312 includes various instructions 1314 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 1304; sending output to display device 1306; keeping track of files and directories on computer-readable medium 1312; controlling peripheral devices (e.g., disk drives, printers, etc.) which can be controlled directly or through an I/O controller; and managing traffic on bus 1310. Network communications instructions 1316 establish and maintain network connections (e.g., software for implementing communication protocols, such as TCP/IP, HTTP, Ethernet, telephony, etc.).

Avatar system instructions 1318 may include instructions that implement one or more of the disclosed modules within avatar system 118, as described throughout this disclosure. Interaction capture model instructions 1320 may include instructions that implement one or more of the disclosed modules within interaction capture model 112, as described throughout this disclosure. Application(s) 1322 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method for two-way avatar conversation, the method comprising:
receiving, via a computing system, an input comprising speech data;
generating, via the computing system, a transcript of the speech data in real-time;
analyzing, via the computing system, the transcript in real-time by:
tagging one or more portions of the transcript based on one or more of conversation context, sentiment, and engagement;
generating, via the computing system, a response to the transcript in real-time based on the tagging;
selecting, via the computing system, one or more avatar animation gestures based on tone and speech patterns of the generated response;
synthesizing, via the computing system, an audible response based on the generated response;
synchronizing, via the computing system, the one or more avatar animation gestures to the synthesized audible response to form a synchronized avatar animation; and
rendering, via the computing system, the synchronized avatar animation.

2. The method of claim 1, further comprising:
determining, via the computing system, a domain based on the analyzing of the transcript.

3. The method of claim 2, wherein the domain comprises one or more of a legal domain, a medical domain, and a customer support domain.

4. The method of claim 1, further comprising:
adapting, via the computing system, the audible response in real-time based on user feedback.

5. The method of claim 1, further comprising:
inputting, via the computing system, the transcript into a blockchain.

6. The method of claim 1, further comprising:
enhancing, via the computing system, the transcript by:
reviewing a conversation history, and
correcting the transcript based on the review of the conversation history.

7. The method of claim 1, further comprising:
adapting, via the computing system, at least one of tone, language complexity, and sentiment of the response based on user engagement.

8. A system comprising:
a non-transitory storage medium storing computer program instructions; and
a processor configured to execute the computer program instructions to cause operations comprising:
receiving, via a computing system, an input comprising speech data;
generating, via the computing system, a transcript of the speech data in real-time;
analyzing, via the computing system, the transcript in real-time by:
tagging one or more portions of the transcript based on one or more of conversation context, sentiment, and engagement;
generating, via the computing system, a response to the transcript in real-time based on the tagging;
selecting, via the computing system, one or more avatar animation gestures based on tone and speech patterns of the generated response;
synthesizing, via the computing system, an audible response based on the generated response;
synchronizing, via the computing system, the one or more avatar animation gestures to the synthesized audible response to form a synchronized avatar animation; and
rendering, via the computing system, the synchronized avatar animation.

9. The system of claim 8, the instructions further comprising:
determining, via the computing system, a domain based on the analyzing of the transcript.

10. The system of claim 9, wherein the domain comprises one or more of a legal domain, a medical domain, and a customer support domain.

11. The system of claim 8, the instructions further comprising:
adapting, via the computing system, the audible response in real-time based on user feedback.

12. The system of claim 8, the instructions further comprising:
inputting, via the computing system, the transcript into a blockchain.

13. The system of claim 8, the instructions further comprising:
enhancing, via the computing system, the transcript by:
reviewing a conversation history, and
correcting the transcript based on the review of the conversation history.

14. The system of claim 8, the instructions further comprising:
adapting, via the computing system, at least one of tone, language complexity, and sentiment of the response based on user engagement.

15. A non-transitory storage medium storing computer program instructions that when executed causes a computing system to perform operations comprising:
receiving, via a computing system, an input comprising speech data;
generating, via the computing system, a transcript of the speech data in real-time;
analyzing, via the computing system, the transcript in real-time by:
tagging one or more portions of the transcript based on one or more of conversation context, sentiment, and engagement;
generating, via the computing system, a response to the transcript in real-time based on the tagging;
selecting, via the computing system, one or more avatar animation gestures based on tone and speech patterns of the generated response;
synthesizing, via the computing system, an audible response based on the generated response;
synchronizing, via the computing system, the one or more avatar animation gestures to the synthesized audible response to form a synchronized avatar animation; and
rendering, via the computing system, the synchronized avatar animation.

16. The non-transitory storage medium of claim 15, the instructions further comprising:
determining, via the computing system, a domain based on the analyzing of the transcript.

17. The non-transitory storage medium of claim 15, the instructions further comprising:
adapting, via the computing system, the audible response in real-time based on user feedback.

18. The non-transitory storage medium of claim 15, the instructions further comprising:
inputting, via the computing system, the transcript into a blockchain.

19. The non-transitory storage medium of claim 15, the instructions further comprising:
enhancing, via the computing system, the transcript by:
reviewing a conversation history, and
correcting the transcript based on the review of the conversation history.

20. The non-transitory storage medium of claim 15, the instructions further comprising:
adapting, via the computing system, at least one of tone, language complexity, and sentiment of the response based on user engagement.
